(19) United States
(12) Patent Application Publication
(10) Pub. No.: US 2014/0206930 A1
(43) Pub. Date: Jul. 24, 2014

(54) TWINNING WITH SEX SORTED SPERM

(71) Applicant: INGURAN, LLC, Navasota, TX (US)

(72) Inventor: Juan Moreno, College Station, TX (US)

(73) Assignee: INGURAN, LLC, Navasota, TX (US)

(21) Appl. No.: 13/831,506

(22) Filed: Mar. 14, 2013

Related U.S. Application Data
(60) Provisional application No. 61/754,413, filed on Jan. 18, 2013.

(51) Int. Cl. A61D 19/04

(52) U.S. Cl. CPC A61D 19/04
USPC 600/34

(57) ABSTRACT

This disclosure relates to methods of producing multiple births of the same sex. Some embodiments relate to methods of boosting the population growth of a herd with genetically desirable females by transferring two embryos fertilized with sex-sorted sperm to recipients.

This application claims the benefit of U.S. Provisional Application No. 61/754,413, filed Jan. 18, 2013, the entire contents of which are incorporated

### FIELD OF THE INVENTION

The present disclosure relates generally to the field of assisted reproductive technology, and relates more particularly to methods of producing multiple same sexed births and boosting the population growth of a herd with sex-sorted sperm.

### BACKGROUND OF THE INVENTION

Many mammals give birth to a single offspring at a time; presenting an obstacle to rapidly improving the genetic characteristics of a herd or to replacing livestock in a herd. Decades of developments in the field of assisted reproductive technology has provided a number of techniques which primarily help control the parentage, and hence the genetics offspring. However, most assisted reproductive technologies provide limited improvements in the speed at which a herd can grow because only females produce offspring, and heifers in particular demonstrate the greatest fertility. For example, synchronization protocols and fertility treatments in combination with artificial insemination and in vitro fertilization provide some increases to the reproductive productivity of cattle by virtue of improving procedural efficiency, but these methods are still limited by gestation periods and fertility cycles.

The occurrence of multiple births, such as fraternal twins, could be induced by super ovulation protocols and hormone treatments for cattle. However, there are known to be a number of disadvantages for twinning in large animals. For example, while twinning might improve cost effectiveness in beef production due to weaning multiple calves simultaneously, each of the cow and the calves may lose reproductive performance creating an overall reduction in productivity in all the animals. For this reason, twinning has not been considered a viable method for rapidly growing a heard. For instance, once a cow has given multiple births, their breeding efficiency is often reduced. Additionally, twin births give rise to a greater number of complications such as shorten gestation periods and dystocia resulting in higher calf mortality. Dystocia is generally defined as difficult or abnormal delivery, but the causes in twins are usually different from the causes in single births. Dystocia may be caused in twins because of low birth weights in addition to a natural biological competition of each offspring to be born first. The benefits of twinning for the purpose of rapidly expanding a herd population are effectively eliminated by freemartinism. Freemartinism is a syndrome that affects the female twin in mixed sex twins. Due to blood mixing between the mixed sex twins during pregnancy, the female is exposed to certain hormones produced in development of the male reproductive tract leaving as many as 90% of females in mixed sex twins infertile.

### SUMMARY OF THE INVENTION

Certain embodiments of this disclosure are summarized below. These embodiments are not intended to limit the scope of the claimed invention, but rather serve as brief descriptions of possible forms of the invention. The invention may encompass a variety of forms that differ from these summaries.

One embodiment relates to a method of producing non-human mammals which may begin with the step of producing at least two embryos having a predetermined sex, wherein the predetermined sex for each embryo is the same, and may continue with the steps of transferring the sexed embryos into a recipient female of the same species and producing multiple births of the same sex.

Another embodiment relates to a method of boosting the population growth of a herd with genetically desirable females. The method may begin with the steps of obtaining sex-sorted sperm of a non-human species of mammal, wherein at least 85% of the sperm cells in the sex-sorted sperm sample comprise X-chromosome bearing sperm and obtaining oocytes of the same non-human species of mammal. At least two embryos can be produced through in vitro fertilization of the oocytes with the sex-sorted sperm. At least two embryos can be transferred into a recipient female of the non-human species of mammal for producing offspring.

### BRIEF DESCRIPTION OF THE DRAWINGS

FIG. 1 illustrates a flow chart of a method in accordance with certain embodiments described herein.

FIG. 2 illustrates a schematic of a system which may be used to obtain sex-sorted sperm.

While the present invention may be embodied with various modifications and alternative forms, specific embodiments are illustrated in the figures and described herein by way of illustrative examples. However, the figures and the detailed descriptions are not intended to limit the scope of the invention to the particular form disclosed, but that all modifications, alternatives, and equivalents falling within the spirit and scope of the claims are intended to be covered.

### DETAILED DESCRIPTION OF THE INVENTION

Embodiments of the present disclosure provide methods for improving the pregnancy rates of females and improving birth and parturition rates for rapidly expanding a herd or replacing livestock. Surprisingly, sex-sorted sperm, and particularly, twin females provide effective means for the rapid herd expansion. In particular, when embryos are pre-selected to produce female twins freemartinism can be avoided, or at least drastically reduced by virtually eliminating mixed sex twins. Additionally, the naturally smaller birth weight of females may help avoid dystocia.

Monozygotic twins, sometimes referred to as identical twins, occur when a fertilized egg splits into two identical parts. Because monozygotic twins come from the same fertilized egg, both individuals are always the same sex. In cattle, however, about less than 10% of all like sexed twins are monozygotic. The remaining twins are fraternal twins resulting in two oocytes being fertilized. Fraternal twins may be born in three combinations. Roughly, half the time the twins will be mixed sex twins; one male and one female. One quarter of the time, the twins will both be male, and one quarter of the time the twins will both be female. Accordingly, about 50% of the females born will be prone to freemartinism with a very high infertility rate.

The controlled birthing of twin females, either by cloning or by using sex-sorted sperm for embryo production in assisted reproductive technologies, such as artificial insemination (AI), in vitro fertilization (IVF), intra-cytoplasmic sperm injection (ICSI), gamete intrafallopian transfer transfer (GIFT) or other similar embryo production transfers procedures, enables multiple births to rapidly expand the size of herds.

Sperm can be readily collected from males and stored for a long period, when frozen. For this reason, sperm is rarely a limiting factor for rapidly expanding a herd. Similarly, oocytes can be collected from slaughterhouse ovaries or may be aspirated from cattle in sufficient numbers for reproductive purposes. Recipient females for gestating and birthing offspring are often the limiting factor in the breeding rate and the number of offspring that may be produced in a herd. In particular, heifers provide greater pregnancy and birth rates, as compared to cows. Therefore, when a heifer is implanted with two female embryos, freemartin syndrome is avoided, and a greater probability exists more heifers will be available in a future reproductive cycle.

Additional complications in twin pregnancies arise from an increased stress on the mother in addition to shorter gestation periods and low birth weights. It has surprisingly been found that the difference in size between males and females is significant enough that twin females are less prone to complications resulting in losing one or both twins or even the mother.

Embryos produced in vitro and implanted do not always result in pregnancies. An additional benefit to implanting multiple female embryos into a single recipient is the improved birth rates provided by redundancy. In much the same way each cow or heifer implanted with an embryo will not necessarily produce an offspring, each cow or heifer implanted with two embryos will not necessarily produce twins. Some percentage of the time only one of the two embryos will come to term. Even in the event of a single pregnancy, a reproductive efficiency is realized because the occurrence of no pregnancy has been reduced.

One aspect of the present disclosure relates to the inclusion of sex-sorted sperm, which is considered to have a high purity. Exemplary systems for sorting sperm into high purity populations can be found in PCT Applications PCT/US01/15150; PCT/US04/015457 and PCT/US04/009646 the entire disclosure of both are incorporated herein by reference. As an example, when two embryos are fertilized with sperm which is 85% pure with respect to the desired sex, there only a 72.25% change both embryos will have the desired sex. In the event sperm is 95% pure with respect to the desired sex, the chance two embryos will end up with the desired sex is 90.25%. The advantages of even slightly higher sperm purity can be is illustrated by the fact sperm samples having purity levels of 98% would likely provide two calves of the desired sex 96% of the time. Sex-sorted sperm having lower purities may also provide significant benefits over conventional sperm. For example, sex-sorted sperm sample having a purity of 80% provides a 64% chance both offspring will be the desired sex. Even lower purity sex-sorted semen samples can be used. For example, any sex-sorted sperm sample having a purity level ranging from about 70% to 100% can result in a 50% or better chance of getting two calves of the desired sex. In comparison, natural fraternal twins, or twins produced from two embryos fertilized with conventional sperm will both be the desired sex about 25% of the time, while mixed sex twins prone to freemartinism occurs 50% of the time.

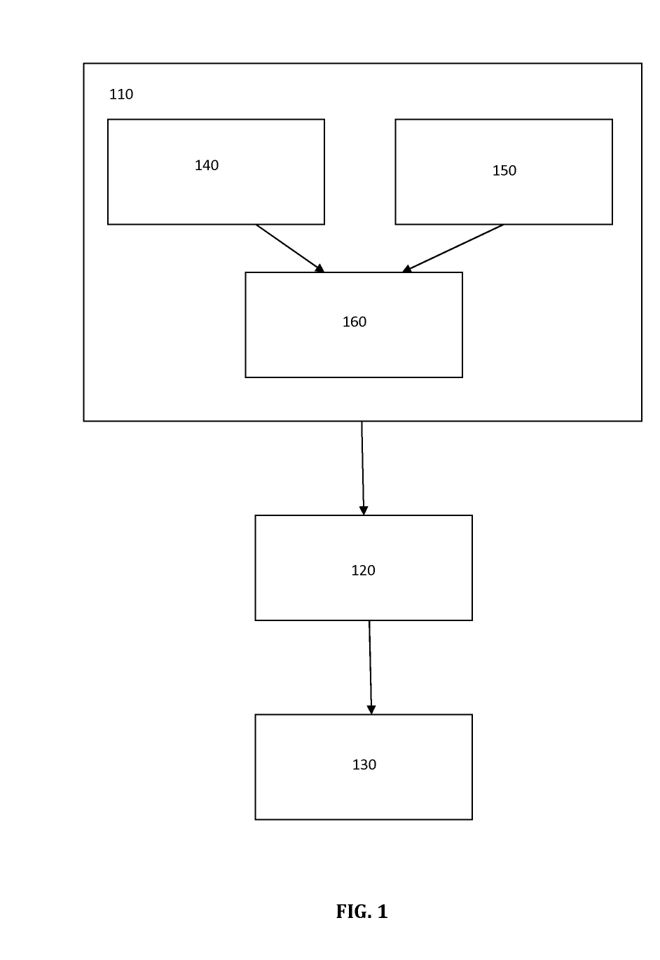

Referring to FIG. 1, a method (100) for improving the reproductive productivity of livestock is illustrated. The improved reproductive productivity may be characterized in terms of producing multiple births, or in terms of boosting the population growth of a herd. In one aspect, the method may increase the number of births per pregnancy, and in another aspect the method may propagate females in a herd quickly to improve future reproductive cycles. The method may begin with the step of producing at least two embryos (110). The at least two embryos may be enriched with respect to a desired sex, increasing the probability both embryos are the same sex. The step of producing at least two embryos (110) may include the steps of obtaining sperm (140), obtaining oocytes (150) and fertilizing the oocytes with the sperm (160).

The step of obtaining sperm (140) may entail the step of sex sorting sperm, but broadly may also entail acquiring previously sex-sorted sperm, such as acquiring a frozen straw of sex-sorted sperm. Sex-sorted sperm may comprise a population of sperm enriched for bearing the X-chromosome or enriched for bearing the Y-chromosome. The sex-sorted sperm, so obtained, may be high purity sperm. For example, the sex-sorted sperm may have a purity of greater than 85% with respect to the desired sex, greater than 86% with respect to the desired sex, greater than 87% with respect to the desired sex, greater than 88% with respect to the desired sex, greater than 89% with respect to the desired sex, greater than 90% with respect to the desired sex, greater than 91% with respect to the desired sex, greater than 92% with respect to the desired sex, greater than 93% with respect to the desired sex, greater than 94% with respect to the desired sex, greater than 95% with respect to the desired sex, greater than 96% with respect to the desired sex, greater than 97% with respect to the desired sex, greater than 98% with respect to the desired sex, or greater than 99% with respect to the desired sex.

The step of obtaining oocytes (150) may broadly be understood to encompass the act of acquiring oocytes, however derived. The step of obtaining oocytes may (150) may also include the steps of collecting and maturing oocytes by known techniques. For example, the collection of oocytes may be performed on known donors by known techniques such Ovum Pick-Up (OPU) or ultrasound assisted OPU, or may be aspirated from the ovaries of a donor by another technique. Oocytes may also be obtained from anonymous donors such as being collected from slaughterhouse ovaries.

The step of fertilization (160) may be performed on each of the at least two embryos with sex-sorted sperm by known techniques. Each of the at least two embryos may be fertilized at the same time with the same sex-sorted sperm sample, or they may be fertilized separately. Similarly, the at least two embryos may be cultured together along with other embryos, or they may be cultured separately.

The method (100) may continue with the step of transferring the at least two embryos to a recipient (120). Recipient females may be heifers or cows. The recipients may also be synchronized or placed on another hormone therapy to increase their receptiveness to receiving transplanted embryos. A treatment may incorporate the use of an intravaginal device releasing progesterone, estradiol benzoate, selenium-ADE vitamins and/or other treatments. Following treatment, for example 17 days after treatment began, a recipient have corpus luteum may have at least two embryos implanted at the uterine horn. The embryos may both be placed in the same uterine horn ipsilateral to the corpus luteum.

Finally, one or more offspring may be produced (130). Since the offspring are produced from an embryo fertilized with sex-sorted sperm, the offspring may be considered to have a predetermined sex, or a selected sex, even though the limitations of sex sorting sperm do not provide for 100% accuracy in sex selection.

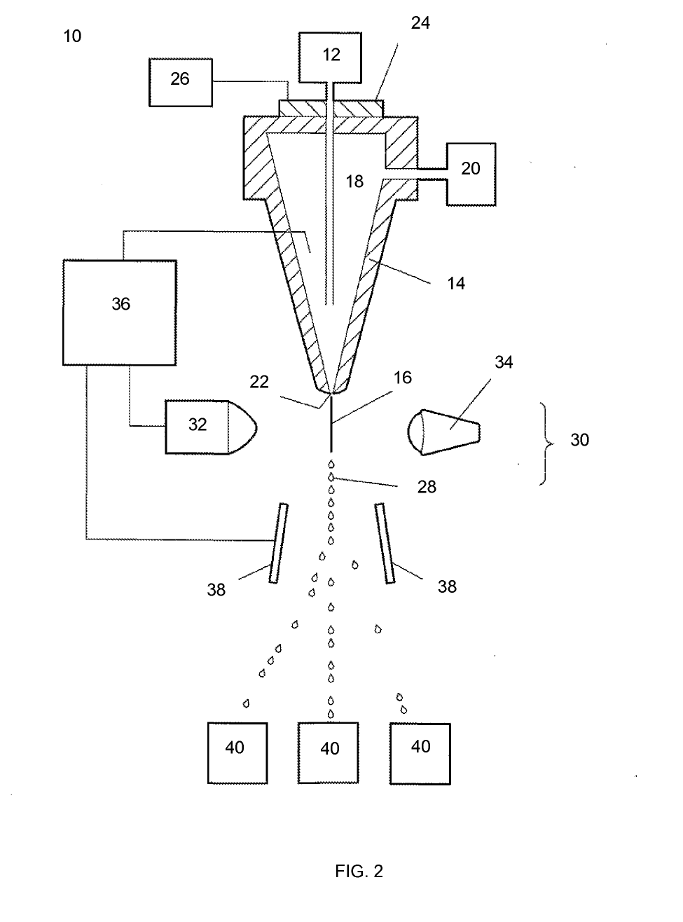

Turning now to FIG. 2, an exemplary flow cytometer (10) is shown for sex-sorting sperm. The flow cytometer (10) includes a cell source (12) supplying a sample for sorting. The sample includes the stained sperm, such as sperm stained with a DNA selective fluorescent dye and one or more other dyes, which may be derived from fresh sperm, neat semen, or a frozen/thawed straw of sperm. The stained sperm are deposited within a nozzle (14) and introduced into a fluid stream (16) of sheath fluid (18). The sheath fluid (18) can be supplied by a sheath fluid source (20) so that as the cell source (12) supplies the sperm into the sheath fluid (18) they are concurrently fed through the nozzle (14). In this manner the sheath fluid (18) forms a fluid stream coaxial to the sample having stained sperm. Since the various fluids are provided to the flow cytometer (10) at some pressure, they flow out of nozzle (14) and exit at the nozzle orifice (22). By providing an oscillator (24) which may be very precisely controlled through an oscillator control (26), pressure waves may be established within the nozzle (14) and transmitted to the fluids exiting the nozzle (14) at nozzle orifice (22). Since the oscillator (24) acts upon the sheath fluid (18), the fluid stream (16) exiting the nozzle orifice (22) eventually and regularly forms drops (28) at precise frequencies and velocities. Because the stained sperm are surrounded by the fluid stream (16) or sheath fluid environment, the drops (28) may contain within them individually isolated spermatozoa.

Since the drops (28) can contain individual spermatozoa, the flow cytometer can be used to sort sperm based upon individual cell characteristics. This is accomplished through a cell sensing system (30). The cell sensing system (30) includes at least a sensor (32) responsive to the cells contained within fluid stream (16). The cell sensing system (30) may cause an action depending upon the relative presence or relative absence of a characteristic. Certain characteristics, such as the relative DNA content of sperm cells, can be detected through excitation with an electromagnetic radiation source (34), such as a laser generating an irradiation beam to which the stained sperm are responsive. The electromagnetic radiation source (34) can be a laser operated at UV wavelength, such as at a wavelength of about 355 nm.

The characteristics of individual sperm, particularly the presence of an X-chromosome or a Y-chromosome can be determined from the detected fluorescence produced in response to the electromagnetic radiation source (34). The DNA selective fluorescent dye binds stoichiometrically to sperm DNA. Because X-chromosome bearing sperm contain more DNA than Y-chromosome bearing sperm, the X-chromosome bearing sperm can bind a greater amount of DNA selective fluorescent dye than Y-chromosome bearing sperm. Thus, by measuring the fluorescence emitted by the bound dye upon excitation, it is possible to differentiate between X-bearing spermatozoa and Y-bearing spermatozoa.

In order to achieve separation and isolation based upon stained sperm characteristics, emitted light can be detected by the sensor (32) and the information fed to an analyzer (36) coupled to a droplet charger which differentially charges each drop (28) based upon the characteristics of the stained sperm contained within that drop (28). In this manner the analyzer (36) acts to permit the electrostatic deflection plates (38) to deflect drops (28) based on whether or not they contain the appropriate particle or cell.

As a result, the flow cytometer (10) acts to separate stained sperm by causing the drops (28) containing sperm to be directed to one or more collection containers (40). For example, when the analyzer differentiates sperm cells based upon a sperm cell characteristic, the droplets entraining X-chromosome bearing spermatozoa can be charged positively and thus deflect in one direction, while the droplets entraining Y-chromosome bearing spermatozoa can be charged negatively and thus deflect the other way, and the wasted stream (that is droplets that do not entrain a particle or cell or entrain undesired or unsortable cells) can be left uncharged and thus is collected in an undeflected stream into a suction tube or the like as discussed in PCT Application PCT/US98/27909 or U.S. Pat. No. 6,149,867, each of which is hereby incorporated by reference herein. Alternatively, the flow cytometer (10) may deflect a single stream of desired cells and allow the remaining cells to remain in a waste stream. Other sorting techniques, such as fluid switching or laser ablation may also be used for the collected of sex-sorted sperm. Sorted sperm may be adjusted to an appropriate concentration and frozen according to the procedures described in PCT Application PCT/US00/30155 and U.S. Pat. No. 7,820,425 the entire contents of each of which are incorporated herein by reference, or may be used prior to any freezing step.

Oocytes may be collected from slaughterhouse ovaries or they may be collected by Ovum Pick-Up (OPU). An example of a procedure for collecting bovine oocytes from a slaughterhouse may be as follows. Cattle ovaries may be collected at a slaughterhouse and may be processed within two or three hours. Cumulus-oocyte-complexes (COC) may then be recovered from small to medium size ovarian antral follicles with a vacuum pump aspiration at a flow rate of 15 to 20 mL per min. Although, other flow rates may also be used. The collected oocytes can be graded morphologically based on the cumulus investment.

Alternatively, oocytes may be collected by an ultrasound assisted OPU. A portable ultrasound unit can be equipped with a sector scanner vaginal probe (ALoka Co. Ltd, Tokyo), together with a single lumen needle fitting a metallic needle guide can be used for transrectal oocyte retrieval; however, other equipment may also be used. Animals can be restrained in a squeeze chute and prepared for follicular aspiration as described by Pieterse et al. in Transvaginal ultrasound guided follicular aspiration of bovine oocytes. Theriogenology; 35:19-24 (1991), the contents of which are incorporated herein by reference in their entirety. An aspiration medium can consist of phosphate-buffered saline (PBS) with the addition of 10 IU/mL heparin and 0.1% polyvinyl alcohol. Although other aspiration medias known for the same purpose may also be used.

Embryos may be produced from the obtained oocytes and sex-sorted sperm by fertilization in the manner previously described by Xu et al., in Developmental potential of vitrified holstein cattle embryos fertilized in vitro with sex-sorted sperm. Journal of Dairy Science 89:2510-18 (2006), the entire contents of which are incorporated herein by reference. Embryos may also be produced by other known fertilization techniques.

Optionally, COCs can be matured prior to fertilization. The oocytes can be matured for 22 to 24 hours in a 50 to 75 μL droplets of Medium 199 (Invitrogen) containing Earle's salts, L-glutamine, 2.2 g/L sodium bicarbonate and 25 mM Hepes, supplemented with 10% (vol/vol) fetal bovine serum (FBS; Hyclone, Logan, Utah), 0.5 μg/mL ovine FSH (National Institute of Diabetes and Digestive and Kidney Disease, NIDDK, Los Angeles), 5.0 μg/mL ovine LH (NIDDK), and 1.0 μg/mL estradiol 17-β. Other commercially available cell culture medias and like may be used for maturing the COCs. For example, TMC199 supplemented with about 10% fetal calf serum plus hormones (15 ng FSH, 1 μg LH, 1 μgE₂/ml) may also be used, as described in PCT Application PCT/US01/45237, the entire disclosure of which is incorporated herein by reference.

Fertilization may be accomplished with frozen/thawed sex-sorted sperm, or with recently sorted sperm. Optionally, sperm may be processed into a desired concentration by centrifugation and resuspension. As one example, sex-sorted sperm can be adjusted to between about 0.5×10⁶ sperm per mL and about 2.0×10⁶ sperm per mL and placed into 50 μL droplets of TALP fertilization medium. Between about 10 and 20 oocytes may be The TALP fertilization medium may be supplemented with 10 μg/mL heparin after adding both sperm and COCs. The sperm and COCs may be co-incubation for about 20 to 24 hours. Presumptive zygotes may then be stripped of enclosing cumulus cells by and then moved into 50 μL droplets of culture medium consisting of synthetic oviduct fluid (SOF) medium with the addition of BSA, essential and non essential amino acids, but no serum (serum free culture). Other fertilization medias may be used such as the Fertilization TALP or the Fertilization TALP supplemented with non-essential amino acids described in PCT Application PCT/US01/45237, the chemically defined medium described in the journal article entitled “Lowered Oxygen Tension and EDTA improve Bovine Zygote Development In Chemically Defined Medium,” J. Anim. Sci. (1999) or the SOF medium described in the journal article “Sucessful Culture In-vitro of sheep and Cattle Ova,” J. Reprod. Fertil. 30:493-497 (1972).

In the case of frozen sex-sorted sperm, straws may contain sex-sorted sperm at concentration of about 8×10⁶ sperm per mL (2×10⁶ sperm per 0.25 mL straw). The straws may be thawed for 10 seconds in a water bath and reconcentrated to between about 0.5×10⁶ sperm per mL and 2.0×10⁶ sperm per mL. Matured COCs may be rinsed in medium supplemented with BSA and heparin. Fertilization droplets (50 μL) containing matured COCs may be prepared and supplement with a 50 μL droplet of sex-sorted sperm concentrated between 0.1×10⁶ sperm per mL and 2.0×10⁶ sperm per mL for a final volume of 100 μL. Presumptive zygotes may be moved into culture droplets of serum free medium described above, or in another commercially available embryo culture media.

Cultures may then be incubated up to the blasyocyst stage in a chamber, such as in a modulation chamber (Form a Scientific, USA), under a mixed gas atmosphere of CO₂ (5%), O₂ (5%) and balanced with N₂ (90%) or the culture may be incubated in a Petri dish or by other conventional embryo incubation methods.

Once the at least two embryos are developed to the blastocyst stage, usually at about 7 days, they may be implanted into a recipient. The recipient may be a cow having previously produced offspring, or a virgin heifer. In order to synchronize a number of recipients cows and heifers alike may receive a hormone releasing implant previously described.

In one embodiment, the embryos may be vitrified, or frozen, prior to implantation in the recipient. The embryos may be frozen according to techniques described by Reubinoff B. E. et al., 2001, Human Reprod. Vol. 16, No. 10, 2187-2194 or Fujioka, T. et al., Int. J. Dev. Biol., 48: 1149-1154 (2004). The embryos may also be frozen according to “minimum drop vitrification techniques” described by Arav., “Vitrification of oocyte and embryos,” in New Trends in embryo Transfer, Portland Press, Cambridge England, 255-264 (1992), Other techniques such as “solid surface vitrification” described in U.S. patent application Ser. No. 09/755,205 may also be used, prior to thawing and fertilization.

### Example 1

Bos indicus cows and heifers (n=25), under free range grazing in the humid tropical zone of Mexico, with body condition scores from 2.6 to 3.6 on a scale of 1 to 9 were used as recipients. The cows and heifers were isolated from bulls for 50 days before synchronization and supplemented 30 days before beginning the protocol with 2 kg commercial feed with 18% protein, 80 g of mineral salts, and 40 ml of corn oil daily until pregnancy diagnosis. The feed, minerals, and vaccinations were the same for all cows and heifers. The following treatment was utilized: Day 0—application of an intravaginal device (ID) with 1.9 g of progesterone (P4), 1 mg IM of Estradiol Benzoate (EB) and 7 ml of Selenium-ADE vitamins IM, Day 8—removal of the ID, 0.15 mg PGF2α IM and 300 i.u. eCG IM, and Day 9—0.5 mg/ml IM of EB. Day 10 was considered the day of estrus. On day 17, for the 23 cows and heifers having a corpus luteum (CL), two fresh sexed semen IVF derived embryos were transferred to the uterine horn ipsilateral to the CL. 7 of the implanted animals were virgin heifers and 16 of the implanted animals were cows which have previously been impregnated. The embryos were produced using oocytes collected by aspiration of ovaries from Bos indicus slaughtered cows and frozen-thawed sexed semen (X-chromosome-bearing) from Bos taurus. The embryos were incubated until the blastocyst stage (7 days) and only Grade 1 embryos were used. Pregnancy was diagnosed by rectal palpation 60 days after embryo transfer. Table 1 indicates the total pregnancy rates and the percentages of twins and single births.

TABLE 1

| | Heifers | Cows | Combined |
|---|---|---|---|
| Transfers | 7 | 16 | 23 |
| Pregnant | 100% (7/7) | 37.5% (6/16) | 56.5% (13/23) |
| Births | 85.7% (6/7) | 83.3% (5/6) | 84.6% (11/13) |
| Twins | 66.7% (4/6) | 60% (3/5) | 63.6% (7/11) |
| Singles | 33.3% (2/6) | 40% (2/5) | 36.4% (4/11) |
| Aborted | 1 | 1 | 2 |

A 56.5% total pregnancy rate (13/23) and a 47.8% total parturition rate (11/23) were obtained. Of 11 parturitions, there were 7 twin and 4 single calves, a total of 18 calves: 16 females and 2 males. The twin calf birth weight average was 30.4 kg, St. Dev.=2.5 kg (range 26 to 33 kg) compared to the single calf birth weight average of 35.8 kg, St. Dev.=1.7 kg (range 34 to 38 kg). In this experiment, each male was born in a single birth, and every set of twins were both females, resulting in no occurrence freemartin syndrome.

### Example 2

Four separate trials were performed in bovine, in a manner similar to Example 1. In each trial cows in their first lactation were used as recipients. Cows where synchronized with a hormonal protocol and implanted with a sex-selected embryo. In each of Trial 1, Trial 2, and Trial 3, the embryos used where frozen/thawed embryos fertilized from sex-sorted sperm. In Trial 4, fresh embryos produced from an IVF procedure with sex-sorted sperm were implanted in the first lactation cows.

| | | | Preg- | | | |
|---|---|---|---|---|---|---|
| | Embryos | Transfers | nancies | Preg- | Twins | Twins |
| | No. | No. | No. | nancies % | No. | % |
| Trial 1 | 144 | 72 | 26 | 36 | 8 | 31 |
| Trial 2 | 68 | 34 | 15 | 44 | 6 | 40 |
| Trial 3 | 134 | 67 | 23 | 34 | 13 | 57 |
| Trial 4 | 210 | 105 | 62 | 59 | 14 | 23 |

The pregnancy rates of 36%, 44%, and 34% in Trials 1, 2, and 3, respectively may have largely been due to the fact frozen/thawed embryos do not perform as well as fresh embryos. The percentage of twins in these trials ranged from 31% to 57%, meaning the overall birthing rate was better than would have otherwise been expected. Trial 4 produced only 23% twins, but a significantly higher pregnancy rate of 59%, which may be considered very good considering the cows were in their first lactation, and were not heifers.

Both instances demonstrate an improved birth rate per pregnancy as compared to conventional techniques. When combined with the sex-selected sperm, it can be understood how sex selected twinning provides means for rapidly expanding a herd by rapidly producing a large number of potential females for future reproductive cycles.

As can be easily understood from the foregoing basic concepts of the present invention may be embodied in a variety of ways. As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action that physical element facilitates. As but one example, the disclosure of “fertilization media” should be understood to encompass disclosure of the act of “fertilizing”—whether explicitly discussed or not—and, conversely, were there effectively disclosure of the act of “fertilizing”, such a disclosure should be understood to encompass disclosure of a “fertilizing” and even a “means for fertilizing.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabriged Dictionary, second edition, each definition hereby incorporated by reference.

Moreover, for the purposes of the present invention, the term “a” or “an” entity refers to one or more of that entity. As such, the terms “a” or “an”, “one or more” and “at least one” can be used interchangeably herein.

The claims set forth in this specification are hereby incorporated by reference as part of this description of the invention, and the application expressly reserves the right to use all of or a portion of such incorporated content of such claims as additional description to support any of or all of the claims or any element or component thereof. The applicant further expressly reserves the right to move any portion, or all of, the incorporated content of such claims or any element or component thereof from the description into the claims or vice versa as necessary to define the matter for which protection is sought by this application or by any subsequent application or continuation, divisional, or continuation-in-part application thereof or to obtain the benefit of, reduction in fees pursuant to or to comply with patent laws, rules, or regulations of any country or treaty. Such content incorporated by reference shall survive during the pendency of this application including any subsequent continuation, division, or continuation-in-part application thereof or any reissue or extension thereon.

I claim:

1. A method of increasing the rate of population growth of a herd comprising the steps of:
obtaining sex-sorted sperm of a non-human species of mammal, wherein the sex-sorted sperm comprises a sperm sample enriched for X-chromosome bearing sperm;
obtaining oocytes of the same non-human species of mammal;
producing at least two embryos through in vitro fertilization of the oocytes with the sex-sorted sperm;
transferring at least two embryos into a recipient female of the non-human species of mammal; and
producing offspring.

2. The method of claim 1 wherein the offspring comprise twins.

3. The method of claim 2 wherein the offspring comprise twin females.

4. The method of claim 2 wherein the twins are produced without the occurrence freemartin syndrome.

5. The method of claim 1 wherein at least 60% of parturition result in twins.

6. The method of claim 1 wherein the offspring comprise triplets.

7. The method of claim 1 wherein the recipient female comprises a heifer.

8. The method of claim 1 wherein the step of producing at least two embryos through in vitro fertilization of the oocytes with the sex-sorted sperm further comprises the step of incubating the at least two embryos.

9. The method of claim 1 wherein each embryo is graded.

10. The method of claim 9 wherein two Grade 1 embryos are transferred to the recipient female.

11. The method of claim 1 wherein the oocytes are collected from F1 cross-bread females.

12. The method of claim 1 wherein the sex-sorted sperm comprises sperm enriched with respect to bearing the X-chromosome having a purity selected from the group consisting of: between 70% to about 100%, between 85% to about 100%, between 90% to about 100%, between about 91% to about 100%, between about 92% to about 100%, between about 93% to about 100%, between about 94% to about 100%, between about 95% to about 100%, between about 96% to about 100%, between about 97% to about 100%, between about 98% to about 100%, between about 99% to about 100%.

13. The method of claim 1 wherein the non-human mammals are selected from the group consisting of: bovine and deer.

14. The method of claim 1 wherein multiple recipient females each receive at least two embryos.

15. The method of claim 14 wherein the number of offspring produced per recipient is selected from the following: at least 0.6 offspring per recipient, at least 0.8 offspring per recipient, at least 1.0 offspring per recipient, at least 1.2 offspring per recipient, at least 1.4 offspring per recipient, at least 1.6 offspring per recipient.

16. A method of increasing the rate of population growth of a herd comprising the steps of:
synchronizing estrus in a group of recipient females;
producing at least one set of at least two embryos in vitro, wherein each embryo has a predetermined sex, and wherein the predetermined sex for each embryo in a set is the same;
transferring at least one set sexed embryos into at least one recipient female of the same species; and
producing multiple births in at least one recipient female.

17. The method of claim 16 wherein the step of producing at least one set of at least two embryos having the same predetermined sex further comprises the steps of:
obtaining a sex-sorted sperm sample;
obtaining at least two oocytes;
fertilizing at least two oocytes with the sex-sorted sperm sample in vitro to produce at least two embryos of a predetermined sex;
incubating the at least two embryos.

18. The method of claim 17 wherein the step of incubating the at least two embryos is performed until embryos reach the blastocysts stage.

19. The method of claim 17 wherein the step of incubating the at least two embryos is performed for between 5 and 8 days.

20. The method of claim 17 wherein after the step of incubating at least two embryos in a fertilization media, each embryo is graded.

21. The method of claim 20 wherein at least two Grade 1 embryos are transferred to the recipient female.

22. The method of claim 17 wherein the oocytes are collected from F1 cross-bread females.

23. The method of claim 17 wherein the sex-sorted sperm comprises sperm enriched with respect to bearing the X-chromosome having a purity selected from the group consisting of: between 70% to about 100%, between 85% to about 100%, between 90% to about 100%, between about 91% to about 100%, between about 92% to about 100%, between about 93% to about 100%, between about 94% to about 100%, between about 95% to about 100%, between about 96% to about 100%, between about 97% to about 100%, between about 98% to about 100%, between about 99% to about 100%.

24. The method of claim 16 wherein the predetermined sex of the embryos is female.

25. The method of claim 16, wherein the multiple births result without the occurrence freemartin syndrome.

26. The method of claim 16 wherein the non-human mammals are selected from the group consisting of: bovine and deer.

27. The method of claim 16 wherein the multiple births comprise twins.

28. The method of claim 16 wherein the multiple births comprise triplets.

29. The method of claim 16 wherein the number of offspring produced per recipient female is selected from the following: at least 0.6 offspring per recipient, at least 0.8 offspring per recipient, at least 1.0 offspring per recipient, at least 1.2 offspring per recipient, at least 1.4 offspring per recipient, at least 1.6 offspring per recipient.
